(19) United States
(12) Patent Application Publication
(10) Pub. No.: US 2026/0310124 A1
(43) Pub. Date: Oct. 8, 2026

(54) INFORMATION PROCESSING APPARATUS, NON-TRANSITORY COMPUTER READABLE MEDIUM, AND RECORDING MEDIUM PROCESSING APPARATUS

(71) Applicant: FUJIFILM Business Innovation Corp., Tokyo (JP)

(72) Inventors: Takashi OGINO, Kanagawa (JP); Nobuhide INABA, Kanagawa (JP); Kumiko TANAKA, Kanagawa (JP); Koji UDAGAWA, Kanagawa (JP)

(73) Assignee: FUJIFILM Business Innovation Corp., Tokyo (JP)

(21) Appl. No.: 19/710,310

(22) Filed: Jun. 16, 2026

Related U.S. Application Data
(63) Continuation of application No. 18/189,182, filed on Mar. 23, 2023.

(30) Foreign Application Priority Data
Sep. 9, 2022 (JP) 2022-143500

(51) Int. Cl. G03G 15/00; B41J 13/00

(52) U.S. Cl. CPC G03G 15/6541; B41J 13/0009

(57) ABSTRACT

An information processing apparatus includes a processor is provided. The processor is configured to acquire stacking order information, which is information on an order of stacking of recording media when binding processing is performed after the recording media are sequentially stacked, and set an amount of moisture to be supplied to each of the recording media based on the stacking order information.

### CROSS-REFERENCE TO RELATED APPLICATIONS

This application is a continuous application of and claims the priority benefit of U.S. application serial no. 18/189,182, filed on Mar. 23, 2023. The prior U.S. application serial no. 18/189,182 is based on and claims priority under 35 USC 119 from Japanese Patent Application No. 2022-143500 filed Sep. 9, 2022.

### BACKGROUND

### TECHNICAL FIELD

The present disclosure relates to an information processing apparatus, a non-transitory computer readable medium, and a recording medium processing apparatus.

### RELATED ART

Japanese Unexamined Patent Application Publication No. 2018-123007 discloses an apparatus including a moisture applying unit that applies water to a position of a sheet bundle to be bound by a pressing unit before the sheet bundle is bound by the pressing unit.

Japanese Unexamined Patent Application Publication No. 2020-172399 discloses a configuration in which a liquid applied region of a sheet bundle where liquid is applied and a pressed region of the sheet bundle pressed by a pressing tooth overlap each other.

Japanese Unexamined Patent Application Publication No. 2015-127116 discloses a moisture supplying unit that supplies moisture to a paper end portion of a paper bundle made up of plural sheets of paper whose end portions in a paper transport direction and end portions in a paper width direction are aligned with one another on a staple tray by a paper bundle aligning unit.

### SUMMARY

Supplying moisture to recording media to be bound can increase strength of binding.

A necessary amount of moisture varies depending on conditions on which the binding processing is performed, and there can arise a situation where too much moisture is supplied to a recording medium or a situation where insufficient moisture is supplied to a recording medium.

Aspects of non-limiting embodiments of the present disclosure relate to a technique for optimizing an amount of moisture supplied to each of recording media to be bound.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: acquire factor information, which is information on a factor that influences an amount of volatilization of moisture supplied to each of recording media to be bound from the recording medium; and set an amount of moisture to be supplied to the recording medium on a basis of the factor information.

### BRIEF DESCRIPTION OF THE DRAWINGS

An exemplary embodiment of the present disclosure will be described in detail based on the following figures, wherein:

FIG. 1 illustrates an overall configuration of an image forming system;

FIG. 2 is a view for explaining a configuration of a first post-processing device;

FIG. 3 illustrates a state of a support plate;

FIG. 4 illustrates a paper accumulating part viewed from an upper side;

FIG. 5 illustrates a binding unit viewed from a direction indicated by arrow V in FIG. 4;

FIG. 6 illustrates a hardware configuration of an information processing apparatus;

FIGS. 7A, 7B, 7C, and 7X, illustrate a relationship table;

FIG. 8 illustrates a relationship table;

FIGS. 9A, 9B, 9C, and 9X, illustrate a relationship table;

FIG. 10 illustrates another example of the configuration of the first post-processing device;

FIGS. 11A and 11B illustrate movement of paper in a place where a moisture supplying part and a moisture removing part are provided;

FIG. 12 illustrates another example of a configuration of the moisture supplying part and the moisture removing part;

FIG. 13 illustrates another example of the configuration of the moisture removing part;

FIG. 14 illustrates another example of the configuration of the moisture removing part;

FIG. 15 illustrates another example of the configuration of the moisture removing part; and

FIG. 16 illustrates another example of a configuration in which moisture is supplied only to a portion to be bound by using a pair of members that are in contact with each other.

### DETAILED DESCRIPTION

An exemplary embodiment of the present disclosure is described below with reference to the attached drawings.

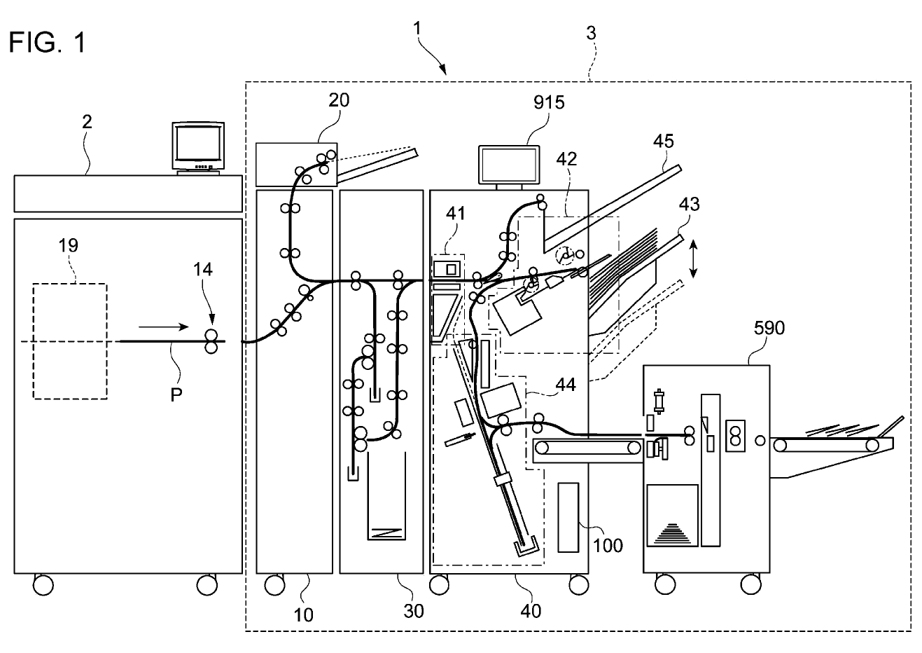

FIG. 1 illustrates an overall configuration of an image forming system 1.

The image forming system 1 illustrated in FIG. 1 includes an image forming apparatus 2 that forms an image on paper P, which is an example of a recording medium, and a paper processing apparatus 3 that performs predetermined processing on paper P on which an image has been formed by the image forming apparatus 2.

The image forming apparatus 2 includes an image forming part 19 that forms an image on paper P by an electrophotographic system or an inkjet system.

Furthermore, the image forming apparatus 2 includes a fixing unit 14. The fixing unit 14 is disposed on a downstream side relative to the image forming part 19 in a transport direction in which paper P is transported.

In the fixing unit 14, paper P on which an image has been formed is pressed and heated. This fixes the image on the paper P onto the paper P.

The paper processing apparatus 3, which is an example of a recording medium processing apparatus, includes a transport device 10 that transports paper P output from the image forming apparatus 2 to a downstream side and a laminated paper supplying device 20 that supplies laminated paper such as cardboard or paper with a window to paper P transported by the transport device 10.

Furthermore, the paper processing apparatus 3 includes a folding device 30 that performs folding processing such as inward tri-folding (C folding) or outward tri-folding (Z folding) on paper P transported from the transport device 10.

Furthermore, the paper processing apparatus 3 includes a first post-processing device 40 that is provided on a downstream side relative to the folding device 30 and performs punching, end stitching, saddle stitching, or the like on paper P.

More specifically, the first post-processing device 40 that performs processing on a paper bundle made up of plural sheets of paper P on which an image has been formed by the image forming apparatus 2 or performs processing on the sheets of paper P one by one is provided on a downstream side relative to the folding device 30.

Furthermore, the paper processing apparatus 3 includes a second post-processing device 590 that is provided on a downstream side relative to the first post-processing device 40 and further performs processing on a paper bundle that has been folded in the middle and saddle-stitched.

Furthermore, the paper processing apparatus 3 includes an information processing apparatus 100 that includes a central processing unit (CPU) for executing a program and controls the whole paper processing apparatus 3.

Furthermore, the paper processing apparatus 3 includes an information display part 915 that displays information for a user. The information display part 915 is a touch panel. The information display part 915 has a receiving function that receives information input by a user in addition to the function of displaying information.

The first post-processing device 40 includes a punching unit 41 that punches paper P and an end stitch binding part 42 that stitches an end of a paper bundle.

Furthermore, a first stacking part 43 on which paper P that has passed the end stitch binding part 42 is stacked and a second stacking part 45 on which paper P that is not subjected to processing in the first post-processing device 40 or paper P that has been subjected to only punching is stacked are provided.

Furthermore, the first post-processing device 40 includes a saddle stitch binding unit 44 that produces a booklet that can be spread out by folding a paper bundle in the middle and saddle-stitching the paper bundle.

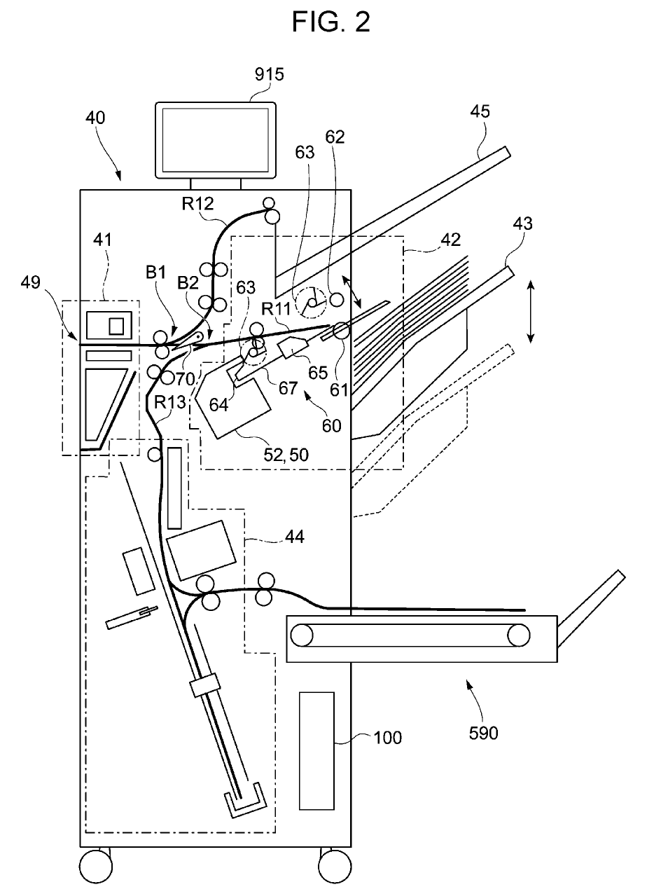

FIG. 2 is a view for explaining a configuration of the first post-processing device 40.

The first post-processing device 40 has an inlet port 49 through which paper P transported from the folding device 30 is received.

The punching unit 41 is provided at a position immediately following the inlet port 49. The punching unit 41 punches, for example, two holes or four holes in paper P transported to the first post-processing device 40.

A first paper transport path R11 used to transport paper P received through the inlet port 49 to the end stitch binding part 42 is provided so as to extend from the inlet port 49 to the end stitch binding part 42.

Furthermore, a second paper transport path R12 used to transport paper P to the second stacking part 45 branches off from the first paper transport path R11 at a first branching part B1.

Furthermore, a third paper transport path R13 used to transport paper P to the saddle stitch binding unit 44 branches off from the first paper transport path R11 at a second branching part B2.

Furthermore, a switching gate 70 that switches a path along which paper P is transported to any one of the first to third paper transport paths R11 to R13 is provided.

The end stitch binding part 42 includes a paper accumulating part 60 that generates a paper bundle by accumulating a necessary number of sheets of paper P.

The paper accumulating part 60 includes a support plate 67 that is inclined with respect to a horizontal direction and supports transported paper P from a lower side. In the present exemplary embodiment, a paper bundle is generated on the support plate 67.

Furthermore, the end stitch binding part 42 includes a binding unit 50 that performs binding (end stitch binding) of an end portion of a paper bundle generated by the paper accumulating part 60.

In the present exemplary embodiment, a binding unit 52 that performs binding processing without using a staple is provided as the binding unit 50.

Furthermore, the end stitch binding part 42 includes a transport roll 61 that is driven to rotate and feeds a paper bundle generated by the paper accumulating part 60 out to the first stacking part 43. Furthermore, a movable roll 62 that is movable to a position where the movable roll 62 is away from the transport roll 61 and a position where the movable roll 62 is pressed against the transport roll 61 is provided.

In a case where processing is performed by the end stitch binding part 42, first, transported paper P is received through the inlet port 49.

Then, the paper P is transported along the first paper transport path R11 and reaches the end stitch binding part 42.

Then, this paper P falls onto the support plate 67 after being transported to a position above the support plate 67. The paper P is supported from a lower side by the support plate 67, and slides on the support plate 67 by inclination given to the support plate 67 and a rotary member 63.

Then, this paper P hits an end guide 64 attached to an end portion of the support plate 67. Specifically, in the present exemplary embodiment, the end guide 64 that extends upward in FIG. 2 is provided on the end portion of the support plate 67, and the paper P moving on the support plate 67 hits the end guide 64.

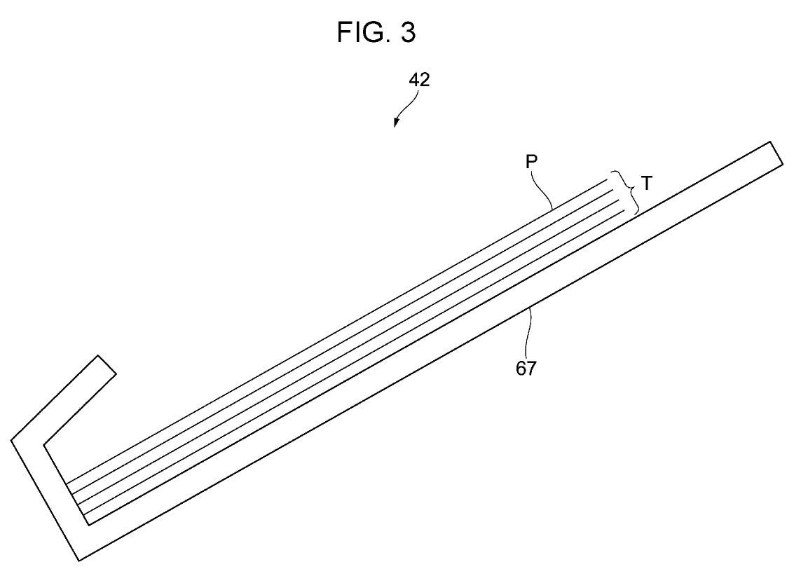

As a result, in the present exemplary embodiment, movement of the paper P stops. Thereafter, this operation is performed every time paper P is transported from an upstream side, and thereby a paper bundle T of plural sheets of paper P that are aligned is generated on the support plate 67, as illustrated in FIG. 3 (which illustrates a state of the support plate 67).

In the present exemplary embodiment, a paper width position aligning member 65 that aligns positions of the sheets of paper P constituting the paper bundle T in a width direction is provided, as illustrated in FIG. 2.

In the present exemplary embodiment, every time paper P is supplied onto the support plate 67, end portions (side portions) of the sheets of paper P in the width direction are pressed by the paper width position aligning member 65, and thus positions of the sheets of paper P in the width direction are aligned.

When a predetermined number of sheets of paper P are stacked on the support plate 67 and the paper bundle T is generated, an end portion of the paper bundle T is bound by the binding unit 52, which is an example of a binding unit.

The binding unit 52 performs binding by fixing the sheets of paper P that constitute the paper bundle T by application of pressure while holding the paper bundle T between two binding teeth.

Then, in the present exemplary embodiment, the movable roll 62 moves toward the transport roll 61, and the paper bundle T is held between the movable roll 62 and the transport roll 61. Then, the transport roll 61 is driven to rotate, and thereby the paper bundle T is transported to the first stacking part 43.

The binding unit 52 is movable toward a depth side and a near side of the paper on which FIG. 2 is drawn, and the paper P can be bound at plural positions in the present exemplary embodiment.

A portion where the end stitch binding part 42 is provided can be grasped as a binding device that binds the paper P.

In the present exemplary embodiment, in a case where end stitching of paper P is performed, paper P on which an image has been formed by the image forming apparatus 2 is transported to the end stitch binding part 42. In the end stitch binding part 42, this paper P transported from the image forming apparatus 2 is bound.

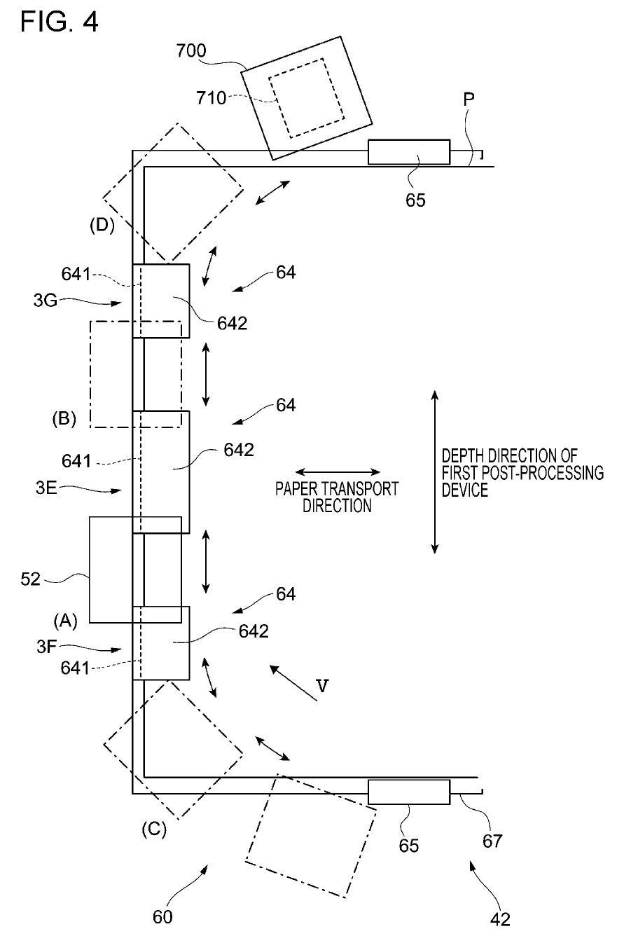

This is further described with reference to FIG. 4 (which illustrates the paper accumulating part 60 viewed from an upper side). In the present exemplary embodiment, the binding unit 52 is provided, as described above.

Furthermore, in the present exemplary embodiment, a moisture adjusting mechanism 700, which is an example of a moisture adjusting unit that adjusts moisture contained in the paper P accumulated on the paper accumulating part 60, is provided.

In the present exemplary embodiment, moisture adjustment is performed by the moisture adjusting mechanism 700 as needed every time paper P is transported to the end stitch binding part 42. More specifically, in the present exemplary embodiment, moisture adjustment is performed by the moisture adjusting mechanism 700 for each paper P, for example, upon receipt of a user's instruction.

Note that this is not restrictive, and moisture adjustment may be performed by the moisture adjusting mechanism 700 after the paper bundle T is generated.

The moisture adjusting mechanism 700, which is an example of a moisture adjusting unit, includes a moisture supplying part 710.

The moisture supplying part 710, which is an example of a moisture supplying unit, supplies moisture to paper P to be bound. More specifically, the moisture supplying part 710 supplies moisture to a portion of the paper P to be bound by the binding unit 52, which is a binding unit.

A mode of supply of moisture by the moisture supplying part 710 may be a known existing one and is not limited in particular. For example, moisture may be supplied by ejecting moisture like inkjet. Alternatively, atomized moisture may be supplied to the portion to be bound.

Note that moisture need just be supplied at least to the portion to be bound, and moisture may be also supplied to a region around the portion to be bound.

The moisture supplied to the paper P is not limited to water and may be one containing a component other than water.

Although the moisture supplying part 710 is movable in the present exemplary embodiment, the moisture supplying part 710 may be fixedly provided.

In a case where the moisture supplying part 710 is fixedly provided, the moisture supplying part 710 is, for example, provided at each binding position of the paper P.

Supply of moisture to the portion to be bound is not limited to a mode in which moisture is supplied by the end stitch binding part 42 (see FIG. 1), and moisture may be supplied in the image forming apparatus 2.

Alternatively, moisture may be supplied to the portion to be bound, for example, in a process of transporting paper P from the image forming apparatus 2 to the end stitch binding part 42.

In other words, moisture may be supplied to the portion to be bound on a transport path along which the paper P moves toward the end stitch binding part 42.

As illustrated in FIG. 4, the binding unit 52 and the moisture adjusting mechanism 700 are disposed at different positions in the depth direction of the first post-processing device 40.

In the present exemplary embodiment, the binding unit 52 and the moisture adjusting mechanism 700 move along the depth direction of the first post-processing device 40, which is a direction orthogonal to the transport direction of the paper P (the paper bundle T).

In the present exemplary embodiment, the binding unit 52 and the moisture adjusting mechanism 700 move along a single common path.

In the present exemplary embodiment, the binding unit 52 is movable and is capable of binding plural positions of the paper bundle T.

In the present exemplary embodiment, the moisture adjusting mechanism 700 is movable and is capable of supplying moisture to plural positions of the paper bundle T.

The binding unit 52, for example, stops at two points (a position (A) and a position (B)) located at different positions in the depth direction of the first post-processing device 40 and perform binding processing at the two points (two-point end stitch binding).

Alternatively, the binding unit 52, for example, stops at one end of the paper bundle T (one corner of the paper bundle T) (a position (D) in FIG. 4) and performs binding processing at this stop position (one-point end stitch binding).

Alternatively, the binding unit 52, for example, stops at the other end of the paper bundle T (the other corner of the paper bundle T) (a position (C) in FIG. 4) and performs binding processing at this stop position (one-point end stitch binding).

The moisture adjusting mechanism 700 also stops at the above points (the position (A) and the position (B) in FIG. 4) and supplies moisture at these two points.

Alternatively, the moisture adjusting mechanism 700, for example, stops at the one end of the paper bundle T (the one corner of the paper bundle T) (the position (D) in FIG. 4) and supplies moisture at this stop position.

Alternatively, the moisture adjusting mechanism 700, for example, stops at the other end of the paper bundle T (the other corner of the paper bundle T) (the position (C) in FIG. 4) and supplies moisture at this stop position.

In the present exemplary embodiment, the binding unit 52 and the moisture adjusting mechanism 700 linearly move between the position (A) and the position (B).

In the present exemplary embodiment, the binding unit 52 and the moisture adjusting mechanism 700 move, for example, while being rotated by 45 degrees between the position (A) and the position (C) and between the position (B) and the position (D).

In a case where the binding unit 52 and the moisture adjusting mechanism 700 are moved, the binding unit 52 and the moisture adjusting mechanism 700 are, for example, provided with a drive source such as a motor. In this case, the binding unit 52 and the moisture adjusting mechanism 700 move on their own.

Alternatively, in a case where the binding unit 52 and the moisture adjusting mechanism 700 are moved, the binding unit 52 and the moisture adjusting mechanism 700 are, for example, attached to a movable belt or the like, and this belt is moved. In this way, the binding unit 52 and the moisture adjusting mechanism 700 move.

In the present exemplary embodiment, plural end guides 64 are provided, as illustrated in FIG. 4.

These end guides 64 are disposed at different positions in the depth direction of the first post-processing device 40 (the direction orthogonal to the transport direction of the paper P).

As illustrated in FIG. 4, each of the end guides 64 has a regulating part 641 and an opposed piece 642.

The regulating part 641 is disposed so as to be orthogonal to the support plate 67. In the present exemplary embodiment, an end portion of paper P hits the regulating part 641, and thereby movement of the paper P is regulated.

The opposed piece 642 is connected to the regulating part 641 and faces the support plate 67.

In the present exemplary embodiment, when paper P is placed on the support plate 67, an end portion of the paper P enters between the opposed piece 642 and the support plate 67. Furthermore, the end portion of the paper P hits the regulating part 641. In this way, sheets of paper P are aligned.

In a case where binding processing is performed at the position (A) in FIG. 4, the binding processing is performed through a gap formed between the opposed piece 642 indicated by reference sign 3E located at a center (a center in an up-down direction) in FIG. 4 and the opposed piece 642 indicated by reference sign 3F located on a lower side in FIG. 4.

Also in a case where moisture is supplied at the position (A) in FIG. 4, moisture is supplied through the gap formed between the opposed piece 642 indicated by reference sign 3E located at the center (the center in the up-down direction) in FIG. 4 and the opposed piece 642 indicated by reference sign 3F located on the lower side in FIG. 4.

In a case where binding processing is performed at the position (B) in FIG. 4, the binding processing is performed through a gap formed between the opposed piece 642 indicated by reference sign 3G located on an upper side in FIG. 4 and the opposed piece 642 indicated by reference sign 3E located at the center in FIG. 4.

Also in a case where moisture is supplied at the position (B) in FIG. 4, moisture is supplied through the gap formed between the opposed piece 642 indicated by reference sign 3G located on the upper side in FIG. 4 and the opposed piece 642 indicated by reference sign 3E located at the center in FIG. 4.

Although a case where the binding unit 52 that does not use a member for binding such as a stapler is used as the binding unit 52 is described as an example in the present exemplary embodiment, the binding unit 52 that uses a member for binding such as a stapler may be additionally provided.

In a case where the binding unit 52 that uses a member for binding is additionally provided, the binding unit 52 used for binding is switched, for example, in response to a user's instruction.

In this case, both of binding processing that does not use a member for binding and binding processing that uses a member for binding can be performed.

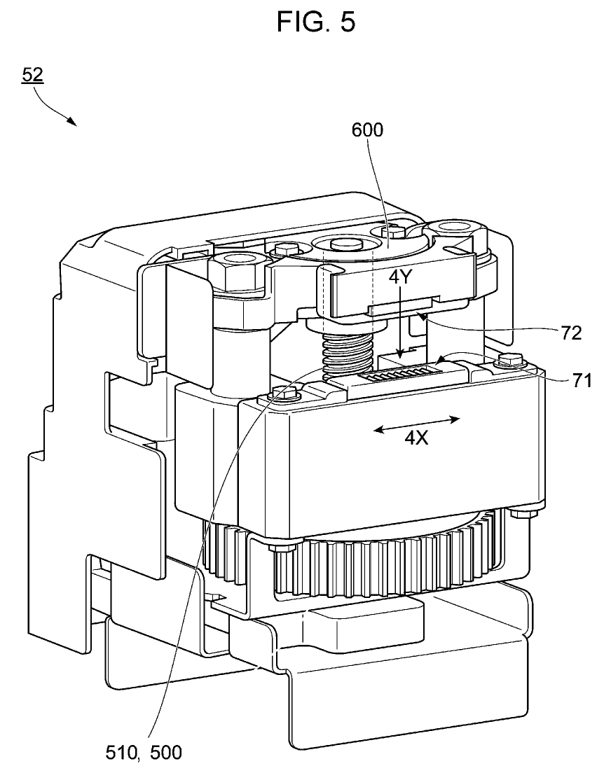

FIG. 5 is a view illustrating the binding unit 52 viewed from a direction indicated by arrow V in FIG. 4.

The binding unit 52, which is an example of a binding unit, is provided with a first binding tooth 71 used for binding of the paper bundle T made up of plural sheets of paper P.

Furthermore, a second binding tooth 72 is provided above the first binding tooth 71.

The first binding tooth 71 and the second binding tooth 72 are each provided with an uneven part.

Specifically, an uneven part having a raised part and a recessed part that are alternately arranged in a direction indicated by arrow 4X in FIG. 5 is provided on a surface of the first binding tooth 71 that faces the second binding tooth 72 and on a surface of the second binding tooth 72 that faces the first binding tooth 71.

In other words, an uneven part having a raised part and a recessed part that are alternately arranged in a longitudinal direction of the first binding tooth 71 and the second binding tooth 72 is provided on the surface of the first binding tooth 71 that faces the second binding tooth 72 and on the surface of the second binding tooth 72 that faces the first binding tooth 71.

In a case where binding processing is performed by the first binding tooth 71 and the second binding tooth 72, the second binding tooth 72 moves toward the first binding tooth 71.

More specifically, in the present exemplary embodiment, in a case where binding processing is performed, the second binding tooth 72 moves toward the first binding tooth 71 by moving downward along a linear path indicated by arrow 4Y in FIG. 5.

Then, in the present exemplary embodiment, the paper bundle T (not illustrated) located between the first binding tooth 71 and the second binding tooth 72 is pressed between the first binding tooth 71 and the second binding tooth 72.

In this state, in the present exemplary embodiment, the raised parts of the first binding tooth 71 and the recessed parts of the second binding tooth 72 face each other. Furthermore, in this state, the recessed parts of the first binding tooth 71 and the raised parts of the second binding tooth 72 face each other.

Furthermore, the raised parts of one binding tooth enter the recessed parts of the other binding tooth.

In this way, the sheets of paper P that constitute the paper bundle T are fastened by pressure, and thereby the sheets of paper P are bound. Then, in the present exemplary embodiment, the second binding tooth 72 moves away from the first binding tooth 71 by moving upward.

Although a case where the raised part and the recessed part are alternately arranged on each of the first binding tooth 71 and the second binding tooth 72 has been described as an example in the present exemplary embodiment, the raised part and the recessed part may be arranged in another way.

In other words, the configuration illustrated in FIG. 5 is an example of the first binding tooth 71 and the second binding tooth 72, and the first binding tooth 71 and the second binding tooth 72 are not limited to the configuration illustrated in FIG. 5 and can have a different configuration.

The binding unit 52 includes a moving mechanism 500, which is an example of a moving unit that moves the second binding tooth 72 toward the first binding tooth 71.

The moving mechanism 500 includes a bar-shaped screw member 510 extending along an up-down direction in FIG. 5, and the second binding tooth 72 is moved toward the first binding tooth 71 by rotating the screw member 510 in a circumferential direction by a drive motor (not illustrated).

In the present exemplary embodiment, a linked part 600 that moves in accordance with movement of the second binding tooth 72 is provided. In the present exemplary embodiment, the screw member 510 is engaged with the linked part 600. In other words, the screw member 510 is connected to the linked part 600.

The moving mechanism 500 moves the second binding tooth 72 toward the first binding tooth 71 by rotating the screw member 510 engaged with the linked part 600 in the circumferential direction.

More specifically, in the present exemplary embodiment, when the drive motor (not illustrated) provided in the binding unit 52 is rotated forward, the screw member 510 rotates in one direction in the circumferential direction.

This moves the linked part 600 and the second binding tooth 72 downward, thereby moving the second binding tooth 72 toward the first binding tooth 71. In this way, binding processing is performed.

When the binding processing ends, the drive motor is reversed, and the screw member 510 rotates in an opposite direction.

This moves the linked part 600 and the second binding tooth 72 upward. When the second binding tooth 72 moves upward, the second binding tooth 72 moves away from the first binding tooth 71.

Although the second binding tooth 72 is moved by using the screw member 510 in the present exemplary embodiment, a mechanism for moving the second binding tooth 72 is not limited in particular, and a different mechanism such as a cam mechanism or a jack mechanism may be used instead.

Although the second binding tooth 72 is moved in the present exemplary embodiment, the first binding tooth 71 may be moved or both of the first binding tooth 71 and the second binding tooth 72 may be moved.

In the present exemplary embodiment, the binding unit 52 is capable of passing through the end guides 64 illustrated in FIG. 4.

More specifically, in the present exemplary embodiment, a maximum distance by which the first binding tooth 71 and the second binding tooth 72 are separated from each other is set larger than a height dimension of the end guides 64. Accordingly, in the present exemplary embodiment, the binding unit 52 is capable of passing through the end guides 64.

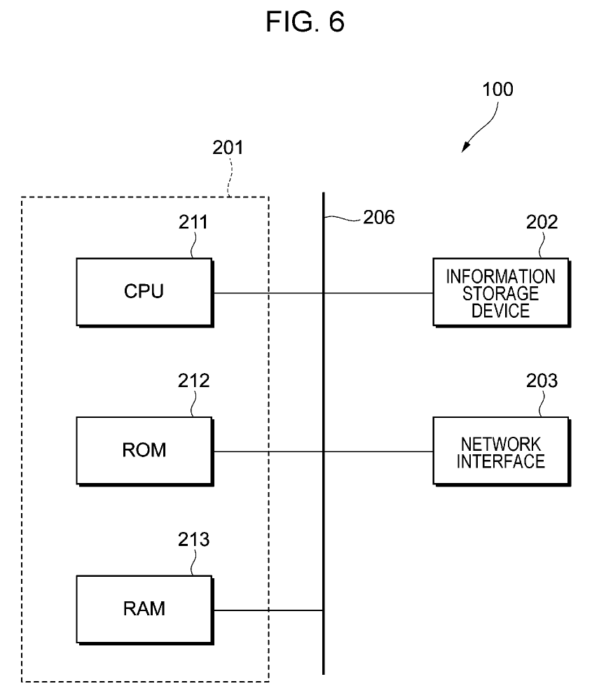

FIG. 6 illustrates a hardware configuration of the information processing apparatus 100.

The information processing apparatus 100 includes a processing part 201, an information storage device 202 in which information is stored, and a network interface 203 that realizes communication over a local area network (LAN) cable or the like.

The processing part 201 is a computer.

The processing part 201 includes a central processing unit (CPU) 211, which is an example of a processor that executes various kinds of processing. Furthermore, the processing part 201 includes a read only memory (ROM) 212 in which software is stored and a random access memory (RAM) 213 used as a work area.

The information storage device 202 is realized by an existing device such as a hard disk drive, a semiconductor memory, or a magnetic tape.

The processing part 201, the information storage device 202, and the network interface 203 are connected through a bus 206 or a signal line (not illustrated).

A program to be executed by the CPU 211 may be offered to the information processing apparatus 100 in a state of being stored in a computer-readable recording medium such as a magnetic recording medium (e.g., a magnetic tape, a magnetic disc), an optical recording medium (e.g., an optical disc), a magnetooptical recording medium, or a semiconductor memory. Alternatively, a program to be executed by the CPU 211 may be offered to the information processing apparatus 100 by using means of communication such as the Internet.

In the embodiments above, the term "processor" refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term "processor" is broad enough to encompass one processor or plural processors in collaboration which are located physically apart from each other but may work cooperatively. The order of operations of the processor is not limited to one described in the embodiments above, and may be changed.

Processing performed by the CPU 211, which is an example of a processor, is described below.

The CPU 211 acquires factor information, which is information on a factor that influences an amount of volatilization of moisture supplied to paper P to be bound from this paper P.

On the basis of the factor information thus acquired, the CPU 211 sets an amount of moisture to be supplied to the paper P.

Then, on the basis of information on the amount of moisture thus set, the CPU 211 controls the moisture supplying part 710 (see FIG. 4) to supply the set amount of moisture to a portion of the paper P to be bound.

Processing based on Elapsed Period Information

Specifically, for example, the CPU 211 acquires, for each paper P, elapsed period information, which is information on an elapsed period from supply of moisture to the paper P to a time of binding of the paper P, as the factor information.

Then, on the basis of the elapsed period information thus acquired, the CPU 211 sets, for each paper P, an amount of moisture to be supplied to the paper P.

More specifically, for example, in a case where a period specified by the elapsed period information exceeds a predetermined period, the CPU 211 sets an amount of moisture to be supplied to the paper P larger than in a case where the period specified by the elapsed period information does not exceed the predetermined period.

In the present exemplary embodiment, sheets of paper P are sequentially stacked on the support plate 67 (see FIG. 3) when the paper bundle T is generated. Accordingly, as for paper P stacked early, an elapsed period from supply of moisture to the paper P to a time of binding of the paper bundle T including the paper P is long.

In other words, as for paper P stacked early, an elapsed period from supply of moisture to the paper P to a time of binding of the paper P by the binding unit 52 is long.

In this case, as for this paper P stacked early, moisture volatilizes more from this paper P, and less moisture is contained in the paper P when binding processing is performed.

On the other hand, as for paper P stacked late, an elapsed period from supply of moisture to the paper P to a time of binding of the paper bundle T including the paper P is short.

In other words, as for paper P stacked late, an elapsed period from supply of moisture to the paper P to a time of binding of the paper P by the binding unit 52 is short.

In this case, as for this paper P stacked late, moisture volatilizes less from this paper P, and more moisture is contained in the paper P when binding processing is performed.

In the present exemplary embodiment, moisture is supplied to the paper P stacked late immediately before binding processing is performed, and an amount of moisture contained in this paper P when binding processing is performed is large.

As described above, in a case where an amount of moisture contained in paper P varies from one paper P to another, there occurs a variation in amount of moisture contained in paper P in a single paper bundle T. This may cause a trouble such as failure to attain expected strength of binding.

In view of this, in the present exemplary embodiment, as for paper P for which the period specified by the elapsed period information exceeds the predetermined period and an elapsed period to a time of binding processing is long, an amount of moisture to be supplied to the paper P is set larger than in a case where the period specified by the elapsed period information does not exceed the predetermined period, as described above.

On the other hand, as for paper P for which the period specified by the elapsed period information does not exceed the predetermined period and an elapsed period to a time of binding processing is short, an amount of moisture to be supplied to the paper P is set smaller than in a case where the period specified by the elapsed period information exceeds the predetermined period.

In a case where this processing is performed, an amount of moisture supplied to paper P by the moisture supplying part 710 is less likely to vary markedly from one paper P to another, and the variation in amount of moisture contained in paper P may be kept small.

Furthermore, in a case where the above processing is performed, a total amount of used water may be reduced as compared with a case where the same amount of moisture is supplied to sheets of paper P.

The CPU 211 acquires the elapsed period information for each paper P, for example, on a basis of a position where the paper P is situated in an order of stacking of paper P in which sheets of paper P are sequentially stacked on the support plate 67 (see FIG. 3) when the paper bundle T is generated.

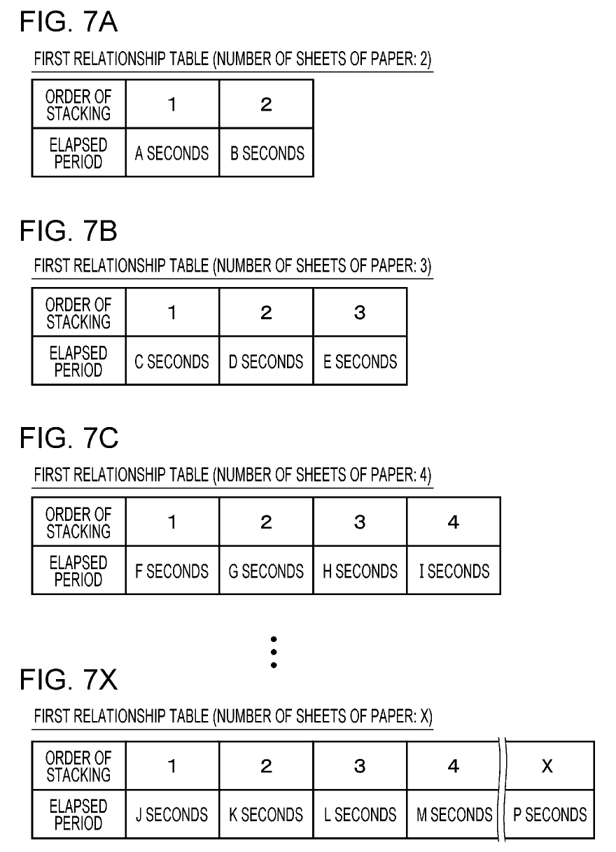

Specifically, for example, the CPU 211 acquires the elapsed period information for each paper P on the basis of a position where the paper P is situated in the order of stacking of paper P by referring to a relationship table (hereinafter referred to as a "first relationship table") illustrated in FIGS. 7A, 7B, 7C and 7X, describing a relationship between a position in the order of stacking and the elapsed period information in advance.

In the present exemplary embodiment, as illustrated in FIGS. 7A, 7B, 7C and 7X, the first relationship table is prepared corresponding to the number of sheets of paper P that constitute the paper bundle T, and the CPU 211 acquires elapsed period information for each paper P on the basis of a position where the paper P is situated in the order of stacking by referring to the first relationship table corresponding to the number of sheets of paper P that constitute the paper bundle T.

In a case where this processing is performed, the first relationship table describing a relationship between a position in the order of stacking and the elapsed period information in advance is registered in advance in the information storage device 202 (see FIG. 6).

The CPU 211 acquires the elapsed period information for each paper P on the basis of information on the number of sheets of paper P that constitute the paper bundle T and information on a position where the paper P is situated in the order of stacking by referring to the first relationship table.

In the present exemplary embodiment, job information, which is information on a print job, includes information on the number of sheets of paper P that constitute the paper bundle T and information on a position where paper P is situated in the order of stacking, and the CPU 211 acquires the elapsed period information for each paper P on the basis of the job information and information registered in the first relationship table.

In the first relationship table, elapsed period information registered for paper P that is situated earlier in the order of stacking is set longer.

Accordingly, in a case where the CPU 211 acquires elapsed period information of paper P that is situated early in the order of stacking, the CPU 211 acquires elapsed period information indicative of a longer period than elapsed period information of paper P that is situated late in the order of stacking.

In a case where the CPU 211 acquires elapsed period information of paper P that is situated late in the order of stacking, the CPU 211 acquires elapsed period information indicative of a shorter period than elapsed period information of paper P that is situated early in the order of stacking.

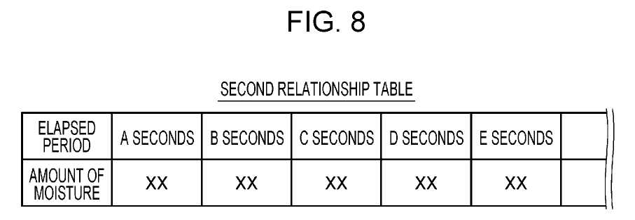

Next, the CPU 211 acquires, for each paper P, information on an amount of moisture to be supplied on the basis of the acquired elapsed period information by referring to a relationship table (hereinafter referred to as a "second relationship table") illustrated in FIG. 8 describing the elapsed period information and an amount of moisture in advance.

In the second relationship table describing a relationship between the elapsed period information and an amount of moisture, information on an amount of moisture is registered so that an amount of moisture to be supplied becomes larger as an elapsed period becomes longer.

In the present exemplary embodiment, in a case where the acquired elapsed period information is long, the CPU 211 acquires information on an amount of moisture indicating that an amount of moisture is larger than in a case where the elapsed period information is short.

In a case where the acquired elapsed period information is short, the CPU 211 acquires information on an amount of moisture indicating that an amount of moisture is smaller than in a case where the elapsed period information is long.

In the second relationship table, a threshold value concerning an elapsed period is substantially set.

In the present exemplary embodiment, in a case where an elapsed period specified by the elapsed period information exceeds a specific threshold value, the CPU 211 acquires information on an amount of moisture indicating that an amount of moisture is larger than in a case where the elapsed period specified by the elapsed period information does not exceed the specific threshold value.

In a case where the elapsed period specified by the elapsed period information does not exceed the specific threshold value, the CPU 211 acquires information on an amount of moisture indicating that an amount of moisture is smaller than in a case where the elapsed period specified by the elapsed period information exceeds the specific threshold value.

Next, the CPU 211 sets an amount of moisture to be supplied to the paper P on the basis of the information on the amount of moisture thus acquired.

Specifically, in this case, the CPU 211 sets the amount of moisture specified by this information on the amount of moisture as an amount of moisture to be supplied to the paper P.

Then, on the basis of information on the amount of moisture thus set, the CPU 211 controls the moisture supplying part 710 (see FIG. 4) to supply the set amount of moisture to a portion of the paper P to be bound.

When the CPU 211 controls the moisture supplying part 710 to supply the set amount of moisture, the CPU 211 causes the set amount of moisture to be supplied, for example, by changing output of the moisture supplying part 710.

Alternatively, the CPU 211 causes the set amount of moisture to be supplied, for example, by changing a period for which the moisture supplying part 710 operates.

Alternative processing is described below.

As alternative processing, the CPU 211 may acquire, as the factor information, stacking order information, which is information on a position where paper P is situated in the order of stacking.

Then, the CPU 211 acquires information on an amount of moisture to be supplied to each paper P on the basis of the stacking order information thus acquired and sets an amount of moisture to be supplied to the paper P on the basis of the information on the amount of moisture.

Although a case where information on an amount of moisture to be supplied to each paper P is acquired on the basis of the elapsed period information acquired on the basis of the stacking order information has been described, information on an amount of moisture to be supplied to each paper P may be acquired directly from the stacking order information without the elapsed period information.

In this processing example, the CPU 211 sets an amount of moisture to be supplied to each paper P on the basis of the stacking order information, which is information on a position where the paper P is situated in the order of stacking when binding processing is performed.

Specifically, in a case where this processing is performed, a relationship table (hereinafter referred to a "third relationship table") describing the stacking order information and an amount of moisture to be supplied is registered in advance in the information storage device 202.

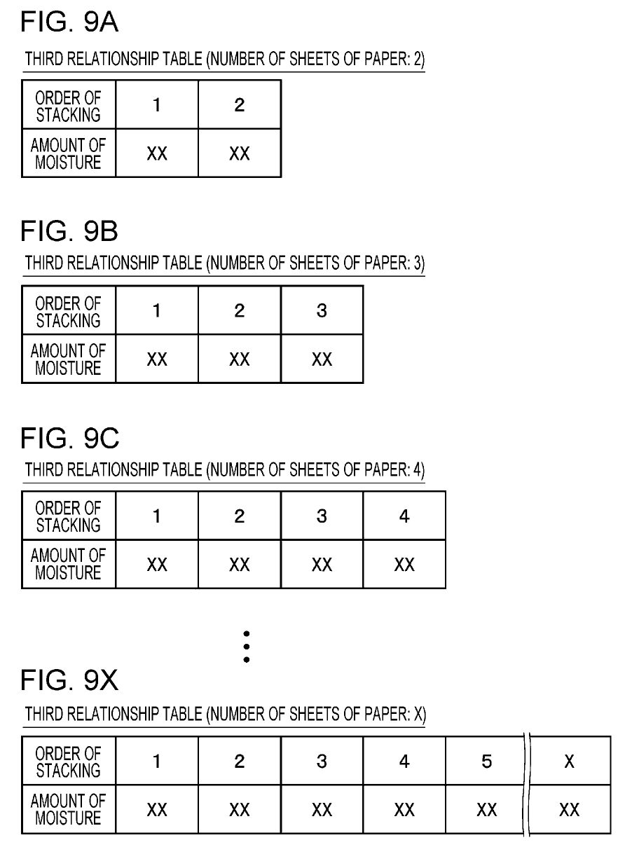

Specifically, for example, as illustrated in FIGS. 9A, 9B, 9C, and 9X, the third relationship table is prepared corresponding to the number of sheets of paper P that constitute the paper bundle T, and these third relationship tables are registered in the information storage device 202.

Then, the CPU 211 sets an amount of moisture to be supplied to each paper P on the basis of information on the number of sheets of paper P that constitute the paper bundle T, the stacking order information, and information registered in the third relationship table registered in the information storage device 202.

In the present exemplary embodiment, the job information includes the information on the number of sheets of paper P that constitute the paper bundle T and information on a position where paper P is situated in the order of stacking, and the CPU 211 set, for each paper P, an amount of moisture to be supplied to the paper P on the basis of the job information and the information registered in the third relationship table.

In the third relationship table, an amount of moisture to be supplied to paper P whose position in the order of stacking specified by the stacking order information is earlier is set larger.

Accordingly, in the present exemplary embodiment, the CPU 211 sets an amount of moisture to be supplied to paper P whose position in the order of stacking specified by the stacking order information is early to a larger amount than an amount of moisture to be supplied to paper P whose position in the order of stacking specified by the stacking order information is late.

Specifically, the CPU 211 acquires, as for paper P whose position in the order of stacking specified by the stacking order information is early, information on an amount of moisture indicating that an amount of moisture is large by referring to the third relationship table. Then, the CPU 211 sets an amount of moisture specified by this information on the amount of moisture as an amount of moisture to be supplied to the paper P.

On the other hand, the CPU 211 sets an amount of moisture to be supplied to paper P whose position in the order of stacking specified by the stacking order information is late to a smaller amount than an amount of moisture to be supplied to paper P whose position in the order of stacking is early.

Specifically, the CPU 211 acquires, as for paper P whose position in the order of stacking specified by the stacking order information is late, information on an amount of moisture indicating that an amount of moisture is small by referring to the third relationship table. Then, the CPU 211 sets an amount of moisture specified by this information on the amount of moisture as an amount of moisture to be supplied to the paper P.

Also in this processing, a threshold value is substantially set, and the CPU 211 sets an amount of moisture to be supplied to paper P whose position in the order of stacking specified by the stacking order information is earlier than a predetermined threshold value to a larger amount than an amount of moisture to be supplied to paper P whose position in the order of stacking is later than the predetermined threshold value.

The CPU 211 sets an amount of moisture to be supplied to paper P whose position in the order of stacking specified by the stacking order information is later than the predetermined threshold value to a smaller amount than an amount of moisture to be supplied to paper P whose position in the order of stacking is earlier than the predetermined threshold value.

Note that in a case where a predetermined condition is met such as a case where the number of sheets of paper P that constitute the paper bundle T is smaller than a predetermined threshold value or a case where a period it takes to generate the paper bundle T is shorter than a predetermined period, a predetermined constant amount of moisture may be supplied to each paper P without changing an amount of moisture to be supplied to each paper P.

In other words, in a case where the predetermined condition is met, a predetermined constant amount of moisture may be supplied to each paper P without the setting of an amount of moisture based on the elapsed period information or the setting of an amount of moisture based on the stacking order information.

Assume a case where the predetermined condition is met such as a case where the number of sheets of paper P that constitute the paper bundle T is smaller than the predetermined threshold value or a case where a period it takes to generate the paper bundle T is shorter than the predetermined period.

In this case, a difference between an elapsed period from supply of moisture to paper P stacked early to a time of binding of this paper P and an elapsed period from supply of moisture to paper P stacked late to a time of binding of this paper P is small.

In this case, even in a case where a predetermined constant amount of moisture is supplied to each paper P, a degree of variation in amount of moisture included in paper P when binding processing is performed is small. In this case, a trouble resulting from a variation in amount of moisture included in paper P is less likely to occur.

When the CPU 211 sets an amount of moisture to be supplied to each paper P on the basis of the elapsed period information or the stacking order information, the CPU 211 desirably sets an amount of moisture to be supplied to each paper P so that amounts of moisture contained in sheets of paper P when binding processing is performed fall within a specific range.

In other words, when the CPU 211 sets an amount of moisture to be supplied to each paper P on the basis of the elapsed period information or the stacking order information, the CPU 211 desirably sets an amount of moisture to be supplied to each paper P so that amounts of moisture contained in sheets of paper P match each other when binding processing is performed.

The CPU 211 may change the specific range so that an amount of moisture included in each paper P when binding processing is performed is changed to another amount.

Specifically, for example, the CPU 211 may change the specific range on the basis of information on an amount of moisture input by a user so that an amount of moisture included in each paper P when binding processing is performed is changed to another amount.

For example, it is assumed that the user wants to increase binding strength between sheets of paper P and the user increases a set amount of moisture.

In this case, the CPU 211 changes the specific range so that a value specified by the specific range becomes larger. This increases an amount of moisture contained in each paper P when binding processing is performed, thereby increasing binding strength between sheets of paper P.

Alternatively, it is assumed that the user wants to lower binding strength between sheets of paper P so that the sheets of paper P are temporarily fastened and the user decreases a set amount of moisture.

In this case, the CPU 211 changes the specific range so that a value specified by the specific range becomes smaller. This decreases an amount of moisture contained in each paper P when binding processing is performed, thereby decreasing binding strength between sheets of paper P.

### Processing Based on Atmosphere Information

Another processing example is described below.

The CPU 211 may acquire, as the factor information, atmosphere information, which is information on an atmosphere in a place where paper P is bound.

Specifically, for example, the CPU 211 acquires, as the atmosphere information, information such as an atmosphere temperature and a humidity in a place where the support plate 67 (see FIG. 2) is provided.

Specifically, in this case, a temperature sensor, a humidity sensor, and the like are provided in the first post-processing device 40 (see FIG. 2), and the CPU 211 acquires information such as an atmosphere temperature or a humidity in a place where the support plate 67 is provided on the basis of output from these sensors.

Then, the CPU 211 sets an amount of moisture to be supplied to paper P on the basis of the atmosphere information thus acquired.

Specifically, in a case where the atmosphere information thus acquired indicates that an amount of volatilization of moisture from paper P is large, the CPU 211 sets an amount of moisture to be supplied to the paper P large.

In a case where the atmosphere information thus acquired indicates that an amount of volatilization of moisture from paper P is small, the CPU 211 sets an amount of moisture to be supplied to the paper P small.

More specifically, in a case where the atmosphere information thus acquired is atmosphere temperature information and an atmosphere temperature specified by the atmosphere temperature information is higher than a predetermined threshold value, the CPU 211 sets an amount of moisture to be supplied to the paper P larger than in a case where the atmosphere temperature specified by the atmosphere temperature information is lower than the threshold value.

In a case where the atmosphere temperature specified by the atmosphere temperature information is lower than the predetermined threshold value, the CPU 211 sets an amount of moisture to be supplied to the paper P smaller than in a case where the atmosphere temperature specified by the atmosphere temperature information is higher than the threshold value.

In a case where the atmosphere information thus acquired is humidity information and a humidity specified by the humidity information is higher than a predetermined threshold value, the CPU 211 sets an amount of moisture to be supplied to the paper P smaller than in a case where the humidity specified by the humidity information is lower than the threshold value.

In a case where the humidity specified by the humidity information is lower than the predetermined threshold value, the CPU 211 sets an amount of moisture to be supplied to the paper P larger than in a case where the humidity specified by the humidity information is higher than the threshold value.

### Processing Based on Paper Type Information

Still another processing example is described below.

The CPU 211 may acquire, as the factor information, type information, which is information on a type of paper P to be bound. In this case, the CPU 211 sets an amount of moisture to be supplied to paper P on the basis of the type information thus acquired.

Specifically, in a case where a type of paper P specified by the type information thus acquired is a type that is hard to hold moisture and permits a large amount of moisture to volatilize from the paper P, the CPU 211 sets an amount of moisture to be supplied to paper P large.

In a case where the type of paper P specified by the type information thus acquired is a type that easily holds moisture and permits only a small amount of moisture to volatilize from the paper P, the CPU 211 sets an amount of moisture to be supplied to paper P small.

More specifically, in a case where this processing is performed, a relationship table (not illustrated) (hereinafter referred to as a "fourth relationship table") describing a relationship between a type of paper P and an amount of moisture is stored in advance in the information storage device 202.

The CPU 211 acquires, for each of sheets of paper P that constitute the paper bundle T, paper type information, which is information on a type of the paper P, on the basis of the job information. This paper type information also includes information on a thickness of the paper P.

Next, the CPU 211 acquires, for each paper P, information on an amount of moisture on the basis of the paper type information thus acquired and information registered in the fourth relationship table.

Then, the CPU 211 sets, as an amount of moisture to be supplied to the paper P, an amount of moisture specified by this information on the amount of moisture thus acquired. The CPU 211 thus sets the amount of moisture for each paper P.

By this processing, a larger amount of moisture is supplied to paper P from which moisture easily volatilizes, and a smaller amount of moisture is supplied to paper P from which moisture is hard to volatilize.

### Processing Based on Moisture Type Information

Still another processing example is described below.

The CPU 211 may acquire, as the factor information, moisture type information, which is information on a type of moisture to be supplied to paper P to be bound.

In this case, the CPU 211 sets an amount of moisture to be supplied to paper P on the basis of the moisture type information thus acquired.

Specifically, in a case where this processing is performed, a relationship table (hereinafter referred to as a "fifth relationship table") (not illustrated) describing a relationship between a type of moisture and an amount of moisture is stored in advance in the information storage device 202.

The CPU 211 first acquires moisture type information, which is information on a type of moisture to be used, when setting an amount of moisture.

Specifically, the CPU 211 acquires moisture type information, which is information on a type of moisture to be used, for example, by acquiring information on a type of moisture input by a user with the use of the information display part 915 (see FIG. 2) or information on a type of moisture included in the job information.

Assume that plural moisture supplying parts 710 (see FIG. 4) are provided, different types of moisture are stored in the plural moisture supplying parts 710, and the moisture supplying part 710 to be used is switched among these plural moisture supplying parts 710.

Also assume, for example, that moisture stored in one moisture supplying part 710 is changed to another type of moisture and this type of moisture is supplied to paper P.

In the present exemplary embodiment, in a case where these aspects are employed, moisture type information, which is information on a type of moisture to be actually supplied to paper P, is acquired.

Then, the CPU 211 acquires information on an amount of moisture on the basis of the moisture type information thus acquired and information stored in the fifth relationship table.

Then, the CPU 211 sets, as an amount of moisture to be supplied to paper P, an amount of moisture specified by the information on the amount of moisture thus acquired.

In a case where this processing is performed, for example, an amount of moisture to be supplied to paper P is set large in a case where the type of moisture to be supplied to the paper P is a type that easily volatilizes.

In a case where this processing is performed, an amount of moisture to be supplied to paper P is set small in a case where the type of moisture to be supplied to the paper P is a type that is hard to volatilize.

### Combination of Processing

Note that although a case where the processing is performed alone has been described above, two or more kinds of processing may be combined.

Specifically, for example, both of the processing of setting an amount of moisture on the basis of the elapsed period information or the processing of setting an amount of moisture on the basis of the stacking order information and the processing of setting an amount of moisture on the basis of the paper type information may be performed.

Furthermore, for example, both of the processing of setting an amount of moisture on the basis of the elapsed period information or the processing of setting an amount of moisture on the basis of the stacking order information and the processing of setting an amount of moisture on the basis of the moisture type information may be performed.

Furthermore, for example, the following three kinds of processing may be performed: the processing of setting an amount of moisture on the basis of the elapsed period information or the processing of setting an amount of moisture on the basis of the stacking order information, the processing of setting an amount of moisture on the basis of the paper type information, and the processing of setting an amount of moisture on the basis of the moisture type information.

Furthermore, for example, both of the processing of setting an amount of moisture on the basis of the paper type information and the processing of setting an amount of moisture on the basis of the moisture type information may be performed.

### Correction of Amount of moisture

Moisture to be supplied to paper P may be corrected in consideration of a temperature of the paper P.

For example, a temperature of the fixing unit 14 gradually increases immediately after the image forming system 1 (see FIG. 1) according to the present exemplary embodiment is powered on.

In this case, a temperature of paper P stacked on the support plate 67 (see FIG. 3) increases with passage of time, and an amount of volatilization of moisture from the paper P increases with passage of time.

Accordingly, it is desirable to correct a set amount of moisture in a case where a predetermined condition is met, for example, immediately after the image forming system 1 is powered on.

Specifically, for example, it is desirable to increase a correction amount with passage of time so that a larger amount of moisture is supplied with passage of time.

This may reduce a possibility of shortage of moisture that can occur due to an increase in temperature of paper P.

### Another Example of Configuration of First Post-processing Device

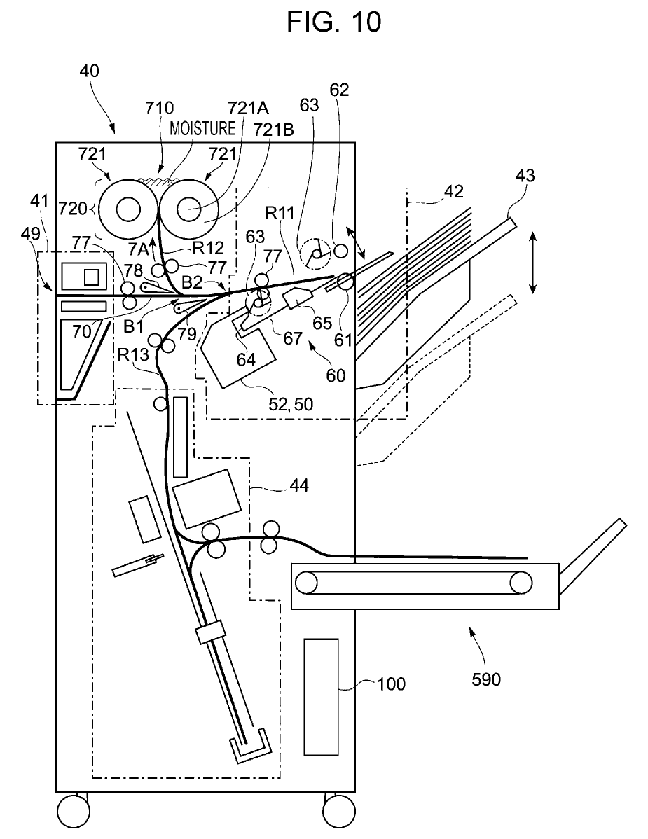

FIG. 10 illustrates another example of a configuration of the first post-processing device 40.

Also in this example, the second paper transport path R12 and the third paper transport path R13 are provided, as in the above example.

The second paper transport path R12 branches from the first paper transport path R11 at the first branching part B1 and extends upward in FIG. 10. The third paper transport path R13 branches from the first paper transport path R11 at the second branching part B2 and extends downward in FIG. 10.

Furthermore, in this example, a first switching gate 78 that switches a path to which paper P is transported is provided at the first branching part B1. Furthermore, a second switching gate 79 that switches a path to which paper P is transported is provided at the second branching part B2.

Furthermore, in this example, the moisture supplying part 710 that supplies moisture to paper P is provided above the second paper transport path R12.

In the present exemplary embodiment, paper P to be bound is transported to a point where the paper P passes the first switching gate 78 by plural transport rolls 77 provided on the first paper transport path R11.

Next, in the present exemplary embodiment, the first switching gate 78 operates, and the first switching gate 78 protrudes on the first paper transport path R11. Furthermore, in this example, the transport rolls 77 are reversed.

This causes the paper P to reach the moisture supplying part 710, which is an example of a moisture supplying unit, by passing along the second paper transport path R12. Then, at the moisture supplying part 710, moisture is supplied to the paper P.

Specifically, in this case, moisture is supplied to a portion of the paper P to be bound, as in the above case.

Then, in this example, the transport rolls 77 are reversed, and thus the paper P is transported toward the support plate 67. In the present exemplary embodiment, this processing is performed for each of sheets of paper P that constitute the paper bundle T.

As a result, also in this case, plural sheets of paper P to which moisture has been supplied are stacked on the support plate 67, and thus the paper bundle T is generated, and then the paper bundle T is bound, as in the above case.

In the example illustrated in FIG. 10, paper P that has moved by passing along the second paper transport path R12b reaches the moisture supplying part 710, and thereby moisture is supplied to the paper P.

Furthermore, in this example, a moisture removing part 720, which is an example of a moisture removing unit that removes a part of moisture supplied to the paper P by the moisture supplying part 710 from the paper P, is provided.

Both of the moisture supplying part 710 and the moisture removing part 720 are disposed on an upstream side relative to a place where the binding unit 52 is provided, which is a place where binding processing is performed, in the transport direction of the paper P.

The moisture supplying part 710 supplies moisture to paper P before the paper P is bound. The moisture removing part 720 also removes a part of moisture supplied to the paper P by the moisture supplying part 710 from the paper P before the paper P is bound.

Also in this example, moisture is supplied to sheets of paper P one by one, and a part of supplied moisture is removed from the sheets of paper P one by one.

The moisture removing part 720 removes moisture that is attached to a surface of paper P without infiltrating the paper P and a part of moisture that has already infiltrated the paper P.

When moisture is supplied to paper P by the moisture supplying part 710, moisture infiltrates the paper P. The moisture removing part 720 removes moisture that is attached to a surface of the paper P without infiltrating the paper P and a part of moisture that has already infiltrated the paper P.

Removing moisture may make it less likely that more moisture than necessary is supplied to paper P. Furthermore, removing moisture may make it less likely that excess moisture on paper P is scattered and is attached to an inside of the apparatus.

The moisture removing part 720 in this example includes a pair of members 721 that are in contact with each other.

In the present exemplary embodiment, paper P moving downward in FIG. 10 passes between the pair of members 721, and thereby a part of moisture supplied to the paper P by the moisture supplying part 710 is removed.

Each of the members 721 has a cylindrical shape and is rotatable.

Furthermore, each of the members 721 includes a metal roll 721A that has a columnar shape and rotates and a cylindrical elastic layer 721B provided on a surface of the metal roll 721A. The elastic layer 721Bis, for example, made of rubber.

In the present exemplary embodiment, one of the members 721 rotates upon receipt of driving force from a motor (not illustrated), which is a drive source, and the other one of the members 721 rotates upon receipt of driving force from the one of the members 721.

A direction indicated by arrow 7A in FIG. 10 is a direction of movement of paper P passing the pair of members 721. In the present exemplary embodiment, each of the members 721 is rotatable about a rotary axis extending along a direction crossing this direction of movement.

More specifically, each of the members 721 is rotatable about a rotary axis extending along a direction orthogonal to this direction of movement.

In the present exemplary embodiment, when paper P moving downward in FIG. 10 passes the rotatable members 721, movement of moisture attached to a surface of the paper P is regulated by the members 721, and thereby the moisture is removed from the paper P.

In the present exemplary embodiment, when paper P moving downward in FIG. 10 passes the rotatable members 721, the paper P is compressed, and moisture is discharged from the paper P by this compression. Then, movement of the discharged moisture is regulated by the members 721, and thereby the moisture is removed from the paper P.

### Explanation of Movement of Paper P

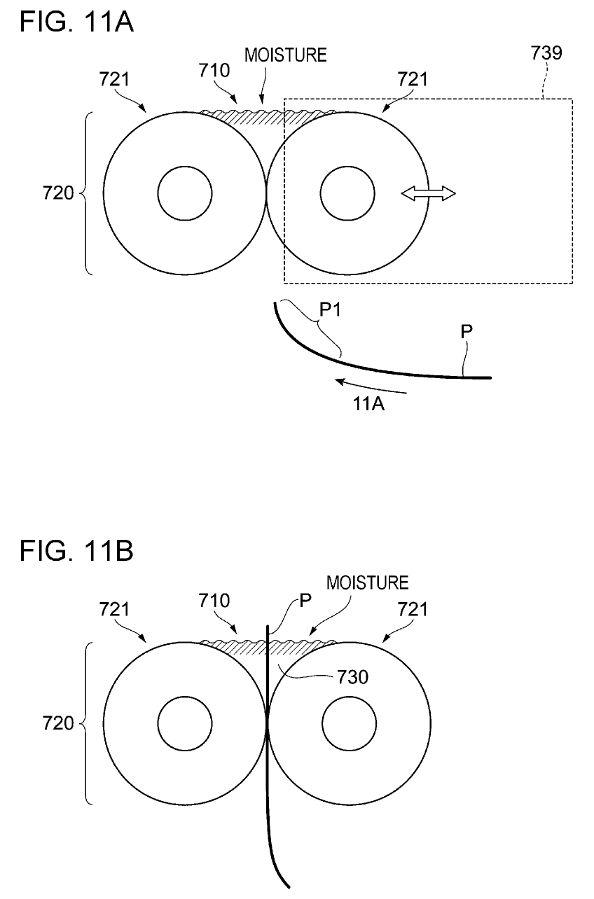

FIGS. 11A and 11B illustrate movement of paper P in a place where the moisture supplying part 710 and the moisture removing part 720 are provided.

When paper P is transported to the moisture supplying part 710 and the moisture removing part 720, first, the paper P is transported in a direction indicated by arrow 11A in FIG. 11A. As a result, at least a portion of the paper P passes the pair of members 721, as illustrated in FIG. 11B.

Specifically, in this example, a leading end portion P1 of the paper P in the transport direction, which is a portion to be bound, passes the pair of members 721.

In the present exemplary embodiment, a moisture storage part 730 in which moisture is stored is provided on a downstream side relative to the pair of members 721 in a direction in which the paper P passes the pair of members 721, as illustrated in FIG. 11B.

Specifically, in this example, moisture is stored in a wedge-shaped region located above the pair of members 721 and located at an exit portion where the paper P exits from the pair of members 721, and this wedge-shaped region serves as the moisture storage part 730.

In the present exemplary embodiment, when at least a portion of the paper P passes the pair of members 721, a portion of the paper P reaches the moisture storage part 730, and moisture in the moisture storage part 730 is supplied to this portion of the paper P.

Note that a period for which the portion of the paper P stops at the moisture storage part 730 may be changed. When the period for which the portion of the paper P stops at the moisture storage part 730 is changed, an amount of moisture supplied to the paper P increases or decreases.

For example, factor information, which is information on a factor that influences an amount of volatilization of moisture supplied to paper P to be bound from the paper P may be acquired as in the above case, and a period for which a portion of the paper P stops at the moisture storage part 730 may be set on the basis of the factor information thus acquired. This increases or decreases moisture to be supplied to the paper P.

In the present exemplary embodiment, a supplying mechanism (not illustrated) that supplies new moisture to the moisture storage part 730 is provided. When an amount of moisture in the moisture storage part 730 becomes small, new moisture is supplied to the moisture storage part 730 by the supplying mechanism.

In the present exemplary embodiment, the pair of members 721 are reversed after the state of FIG. 11B, and the paper P that has passed the pair of members 721 moves in an opposite direction.

At this time, a pressure is applied from the pair of members 721 to the portion of the paper P to which moisture has been supplied, and a degree of infiltration of moisture into the paper P increases as compared with a case where this pressure is not applied.

Furthermore, movement of moisture attached to a surface of the paper P is regulated by the rotary members 721, and thus this moisture is removed from the paper P.

Furthermore, the paper P is compressed, and excess moisture is discharged from the paper P by this compression. Movement of the discharged moisture is regulated by the rotary members 721, and thus this moisture is removed from the paper P.

In a case where water is supplied to a portion of paper P as in the present exemplary embodiment, a decrease in quality of the paper P resulting from supply of moisture to the entire paper P may be kept small.

As another method for supplying moisture to paper P, a method of causing an entire portion of the paper P to pass between rotary members (not illustrated) having a wet outer circumferential surface may be employed.

In this case, moisture is supplied to the entire paper P. This tends to invite a decrease in quality of the paper P resulting from supply of moisture to the entire paper P. Furthermore, in this case, consumption of moisture increases.

On the other hand, in the present exemplary embodiment, since water is supplied to a portion of paper P, a decrease in quality of the paper P resulting from supply of moisture to the entire paper P may be kept small, and consumption of moisture may be made small.

As another method for increasing a degree of infiltration of moisture into paper P, a method of reforming moisture, for example, by adding a surfactant to the moisture may be employed. In this case, a material for the reforming is needed, and an operation burden on an operator increases.

Although an aspect in which moisture is supplied to paper P by using an inkjet head or the like may be employed, it is necessary to decrease surface tension by adding a surfactant or the like to the moisture also in this case, and a material for the reforming is needed, and an operation burden on an operator increases also in this case. Furthermore, cost increases, and a control system becomes complicated.

On the other hand, in a case where a degree of infiltration of moisture into paper P is increased by applying a pressure to the paper P as in the present exemplary embodiment, a material for reforming is unnecessary, and an increase in operation burden on an operator may be kept small.

In the configuration of the present exemplary embodiment illustrated in FIGS. 11A and 11B, paper P moves from a lower side toward an upper side when the paper P first passes the pair of members 721. In the present exemplary embodiment, as described above, since the moisture storage part 730 is provided above the pair of members 721, a portion of the paper P reaches the moisture storage part 730 as a result of the movement of the paper P from the lower side to an upper side.

Then, in the present exemplary embodiment, the pair of members 721 are reversed, and thus this portion of the paper P passes the pair of members 721. At this time, movement of a part of moisture supplied to the paper P is regulated by the pair of members 721, and a part of moisture is removed by the pair of members 721.

If moisture is merely supplied to paper P, a trouble such as a situation where binding processing is performed although moisture has not infiltrated the paper P may undesirably occur.

On the other hand, according to the configuration of the present exemplary embodiment, a pressure is applied to paper P, and thereby a degree of infiltration of moisture into the paper P increases. Furthermore, in the present exemplary embodiment, excess moisture is removed by the pair of members 721.

Note that a way in which the moisture supplying part 710 and the moisture removing part 720 are installed is not limited to the one illustrated in FIGS. 11A and 11B.

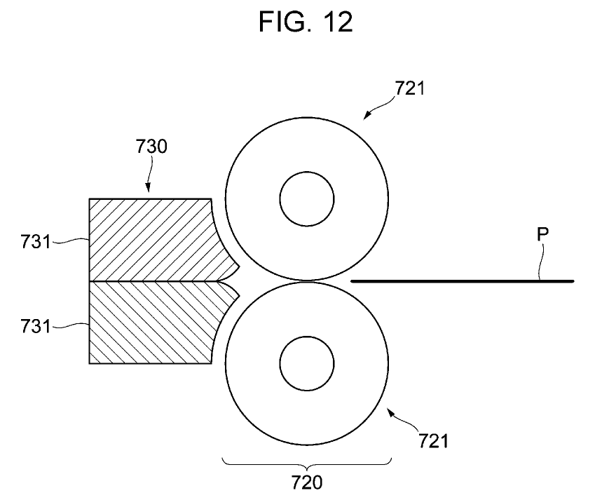

As illustrated in FIG. 12 (which illustrates another example of a configuration of the moisture supplying part and the moisture removing part), the pair of members 721 may be arranged in an up-down direction so that paper P moves along a horizontal direction, and the moisture storage part 730 may be provided beside the pair of members 721.

In this example, two impregnated members 731 impregnated with moisture are provided on a left side relative to the pair of members 721 in FIG. 12, and a place where the two impregnated members 731 are placed serves as the moisture storage part 730.

In this example, paper P that has passed the pair of rotary members 721 enters between the two impregnated members 731 and makes contact with the two impregnated members 731, and thereby moisture is supplied to this paper P.

In this example, after the paper P makes contact with the two impregnated members 731, this paper P moves in an opposite direction, as in the above case. In this way, a part of moisture supplied to the paper P is removed by the moisture removing part 720.

Note that a moving-back-and-forth mechanism 739, which is an example of a moving-back-and-forth unit that moves at least one of the members 721 back and forth relative to the other one of the members 721, may be provided, as illustrated in FIG. 11A.

In this case, a degree of infiltration of moisture into paper P may be adjusted.

In a case where one member 721 is brought closer to the other member 721, a degree of infiltration of moisture into paper P becomes large. In a case where one member 721 is moved in a direction away from the other member 721 and a contact pressure between the one member 721 and the other member 721 is decreased, a degree of infiltration of moisture into paper P becomes small.

For example, in a case where the number of sheets of paper P that are processed per unit time is large and the paper P passes the pair of members 721 at a high speed, a degree of infiltration of moisture into the paper P may undesirably decrease. In this case, when one member 721 is brought close to the other member 721, a degree of infiltration of moisture into the paper P is increased.

Specifically, in the present exemplary embodiment, in a case where a speed at which paper P passes the pair of members 721 is higher than a predetermined threshold value, at least one of the members 721 is brought closer to the other one of the members 721 than in a case where the speed at which the paper P passes the pair of members 721 is not higher than the predetermined threshold value. This increases a degree of infiltration of moisture into the paper P.

In the configuration in which paper P passes between the pair of members 721, a degree of infiltration of moisture into the paper P may be changed by changing a transport speed of the paper P.

In this case, to increase a degree of infiltration of moisture into the paper P, a speed at which the paper P passes between the pair of members 721 is decreased.

To decrease a degree of infiltration of moisture into the paper P, the speed at which the paper P passes between the pair of members 721 is increased.

### Another Example of Configuration

Still another example of the configuration is described below.

The moisture removing part 720 may remove moisture attached to paper P by moving along a surface of the paper P relative to this surface while making contact with this surface.

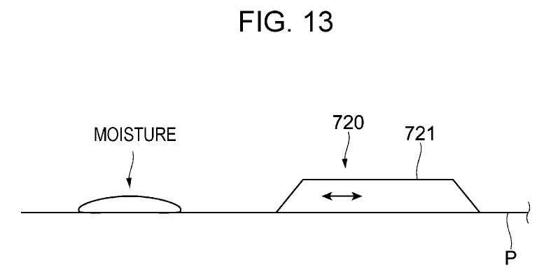

Specifically, for example, as illustrated in FIG. 13 (which illustrates another example of the configuration of the moisture removing part), a moving member 721 that functions as the moisture removing part 720 may remove moisture on a surface of paper P by moving along the surface of the paper P.

Although a case where the moisture removing part 720 moves has been described as relative movement of the moisture removing part 720 to paper P, the paper P may move. Alternatively, both of the moisture removing part 720 and the paper P may move.

### Another Example of Configuration

Still another example of the configuration is described below.

The moisture removing part 720 may be an absorber that absorbs moisture, and a part of moisture supplied to paper P may be removed by using this absorber.

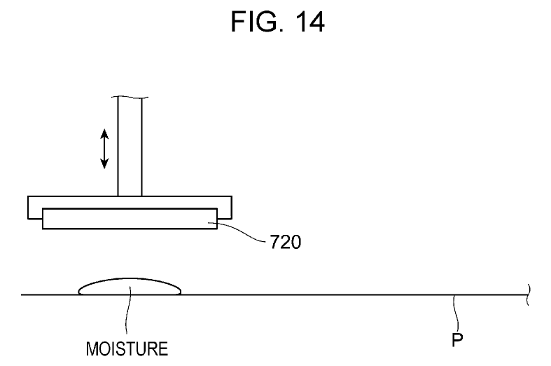

Specifically, for example, as illustrated in FIG. 14 (which illustrates another example of the configuration of the moisture removing part), the moisture removing part 720 may be made of a porous material such as sponge, and a part of moisture supplied to paper P may be removed by bringing the moisture removing part 720 into contact with the paper P.

In this case, moisture that has already infiltrated into the paper P is sucked out and removed or moisture on a surface of the paper P is sucked and removed.

### Another Example of Configuration

Still another example of the configuration is described below.

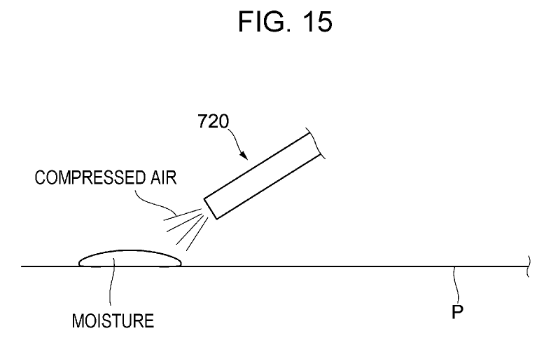

As illustrated in FIG. 15 (which illustrates another example of the configuration of the moisture removing part), the moisture removing part 720 may remove a part of moisture supplied to paper P by spraying gas such as compressed air to the paper P.

In this example, gas is sprayed onto paper P, and moisture on a surface of the paper P is moved to a place other than the paper P by this gas. In this way, a part of moisture supplied to the paper P is removed.

### Another Example of Configuration

The configuration in which a pressure is applied to paper P to increase a degree of infiltration of moisture into the paper P has been described above as an example.

Note that a degree of infiltration of moisture into paper P may be increased by another configuration. For example, moisture may be supplied to a portion of paper P to be bound by inserting plural needles into the portion to be bound. This may also increase a degree of infiltration of moisture into paper P.

Although the configuration in which paper P passes between the pair of members 721 that are in contact with each other has been described above, moisture may be supplied only to a portion of paper P to be bound by using the pair of members 721 that are in contact with each other.

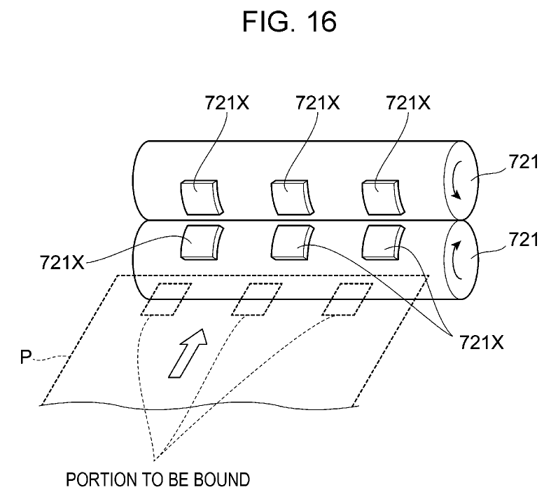

FIG. 16 illustrates an example in which moisture is supplied only to a portion to be bound by using the pair of members 721 that are in contact with each other.

In this example, a raised part 721X is provided on an outer circumferential surface of each of the members 721. Furthermore, a supply roll (not illustrated) that supplies moisture to a surface of the raised part 721X is provided.

In this example, moisture in a moisture storage part (not illustrated) is attached to an outer circumferential surface of the supply roll, and moisture attached to the outer circumferential surface is attached to the raised part 721X provided on each of the members 721. Then, moisture attached to the raised part 721Xis attached to a portion of paper P to be bound.

When moisture is supplied to paper P, moisture may be supplied only to a portion to be bound, as in the example illustrated in FIG. 16.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

### 1

An information processing apparatus including:

a processor configured to:

acquire factor information, which is information on a factor that influences an amount of volatilization of moisture supplied to each of recording media to be bound from the recording medium; and

set an amount of moisture to be supplied to the recording medium on a basis of the factor information.

### 2

The information processing apparatus according to (((1))), wherein

the processor is configured to:

acquire, as the factor information, elapsed period information, which is information on an elapsed period from supply of moisture to the recording medium to a time of binding of the recording medium; and

set an amount of moisture to be supplied to the recording medium on a basis of the elapsed period information.

### 3

The information processing apparatus according to (((2))), wherein

the processor is configured to set an amount of moisture to be supplied to the recording medium larger in a case where a period specified by the elapsed period information exceeds a predetermined period than in a case where the period specified by the elapsed period information does not exceed the predetermined period.

### 4

The information processing apparatus according to (((2))), wherein

the processor is configured to acquire the elapsed period information for each of the recording media on a basis of a position where the recording medium is situated in an order of stacking in which the recording media to be bound are sequentially stacked.

### 5

The information processing apparatus according to (((4))), wherein

the processor is configured to acquire, as the elapsed period information for a recording medium that is situated late in the order of stacking, elapsed period information indicative of a shorter period than a period specified by the elapsed period information acquired for a recording medium that is situated early in the order of stacking.

### 6

The information processing apparatus according to (((1))), wherein

the processor is configured to:

acquire, as the factor information, stacking order information, which is information on a position where a recording medium is situated in an order of stacking in which the recording media to be bound are sequentially stacked; and

set an amount of moisture to be supplied to each of the recording media on a basis of the stacking order information.

### 7

The information processing apparatus according to (((6))), wherein

the processor is configured to set a smaller amount of moisture as an amount of moisture to be supplied to a recording medium whose position in the order of stacking specified by the stacking order information is late than an amount of moisture to be supplied to a recording medium whose position in the order of stacking specified by the stacking order information is early.

### 8

The information processing apparatus according to (((1))), wherein

the processor is configured to:

acquire, as the factor information, atmosphere information, which is information on an atmosphere in a place where the recording media are bound; and

set an amount of moisture to be supplied to each of the recording media on a basis of the atmosphere information.

### 9

The information processing apparatus according to (((1))), wherein

the processor is configured to:

acquire, as the factor information, type information, which is information on a type of each of the recording media to be bound; and

set an amount of moisture to be supplied to the recording medium on a basis of the type information.

### 10

The information processing apparatus according to (((1))), wherein

the processor is configured to:

acquire, as the factor information, moisture type information, which is information on a type of moisture to be supplied to the recording media to be bound; and

set an amount of moisture to be supplied to each of the recording media on a basis of the moisture type information.

### 11

A program causing a computer to execute a process, the process including:

acquiring factor information, which is information on a factor that influences an amount of volatilization of moisture supplied to each of recording media to be bound from the recording medium; and

setting an amount of moisture to be supplied to the recording medium on a basis of the factor information.

### 12

A recording medium processing apparatus including:

a binding unit that binds a recording medium; and

an information processing apparatus that sets an amount of moisture to be supplied to the recording medium to be bound by the binding unit,

wherein the information processing apparatus includes the information processing apparatus according to any one of (((1))) to (((10))).

### 13

A recording medium processing apparatus including:

a moisture supplying unit that supplies moisture to a recording medium to be bound; and

a moisture removing unit that removes a part of moisture supplied to the recording medium by the moisture supplying unit from the recording medium.

### 14

The recording medium processing apparatus according to (((13))), wherein

the moisture removing unit removes the part before the recording medium is bound.

### 15

The recording medium processing apparatus according to (((13))) or (((14))), wherein

the moisture removing unit removes moisture that is attached to a surface of the recording medium without infiltrating the recording medium.

### 16

The recording medium processing apparatus according to any one of (((13))) to (((15))), wherein

the moisture removing unit removes moisture attached to the recording medium by moving along a surface of the recording medium relative to the surface while making contact with the surface.

### 17

The recording medium processing apparatus according to any one of (((13))) to (((15))), wherein

the moisture removing unit includes a pair of members that are in contact with each other; and

the recording medium passes between the pair of members, and thereby a part of moisture supplied to the recording medium is removed.

### 18

The recording medium processing apparatus according to (((17))), further including a moving-back-and-forth unit that moves at least one of the members back and forth relative to the other one of the members.

### 19

The recording medium processing apparatus according to (((17))) or (((18))), wherein

each of the members is rotatable about a rotary axis extending along a direction crossing a direction of movement of the recording medium passing the pair of members.

### 20

The recording medium processing apparatus according to any one of (((13))) to (((15))), wherein

the moisture removing unit removes a part of moisture supplied to the recording medium by using an absorber that absorbs moisture.

### 21

The recording medium processing apparatus according to any one of (((13))) to (((15))), wherein

the moisture removing unit removes a part of moisture supplied to the recording medium by spraying gas onto the recording medium.

### 22

The recording medium processing apparatus according to any one of (((13))) to (((15))), wherein

the moisture removing unit includes a pair of rotary members that are in contact with each other and are rotatable and which at least a part of the recording medium passes;

a moisture storage part in which moisture is stored is provided on a downstream side relative to the pair of rotary members in a direction in which the recording medium passes the pair of rotary members;

at least a part of the recording medium passes the pair of rotary members, and thereby moisture in the moisture storage part is supplied to the recording medium; and

the recording medium that has passed the rotary members moves in an opposite direction, and thereby a part of the moisture supplied to the recording medium is removed by the rotary members.

### 23

The recording medium processing apparatus according to (((22))), wherein

the recording medium moves from a lower side toward an upper side when passing the pair of rotary members; and

the moisture storage part is provided above the pair of rotary members.

What is claimed is:

1. An information processing apparatus comprising:
a processor configured to:
acquire stacking order information, which is information on an order of stacking of recording media when binding processing is performed after the recording media are sequentially stacked; and
set an amount of moisture to be supplied to each of the recording media based on the stacking order information.

2. The information processing apparatus according to claim 1, wherein:
the processor is configured to set an amount of moisture to be supplied to a recording medium whose position in the order of stacking specified by the stacking order information is later to be smaller than an amount of moisture to be supplied to a recording medium whose position in the order of stacking specified by the stacking order information is earlier.

3. The information processing apparatus according to claim 1, wherein:
the processor is configured to acquire, directly from the stacking order information, information on an amount of moisture to be supplied to each of the recording media, without being based on elapsed period information that influences an amount of volatilization from the recording medium of moisture supplied to the recording medium on which binding processing is performed.

4. The information processing apparatus according to claim 1, wherein:
the processor is configured to set a threshold value in the order of stacking specified by the stacking order information.

5. The information processing apparatus according to claim 1, wherein:
the processor is configured to set an amount of moisture to be supplied to a recording medium whose position in the order of stacking specified by the stacking order information is earlier than a predetermined threshold value to be larger than an amount of moisture to be supplied to a recording medium whose position in the order of stacking specified by the stacking order information is later than the predetermined threshold value.

6. The information processing apparatus according to claim 5, wherein:
the processor is configured to set an amount of moisture to be supplied to a recording medium whose position in the order of stacking specified by the stacking order information is later than the predetermined threshold value to be smaller than an amount of moisture so as to be supplied to a recording medium whose position in the order of stacking specified by the stacking order information is earlier than the predetermined threshold value.

7. The information processing apparatus according to claim 1, wherein:
the processor is configured to set, in a case where a predetermined condition is satisfied, a predetermined constant amount of moisture to be supplied to a recording medium satisfying the predetermined condition even when the stacking order information is different.

8. A recording medium processing apparatus comprising:
a stacking unit that stacks recording media;
a binding processing unit that performs binding processing after the recording media are sequentially stacked on the stacking unit; and
a moisture supplying unit that supplies moisture to the recording media on which the binding processing is performed by the binding processing unit,
wherein a larger amount of moisture is supplied by the moisture supplying unit to a recording medium stacked earlier on the stacking unit than to a recording medium stacked later on the stacking unit.

9. The recording medium processing apparatus according to claim 8, wherein
the moisture supplying unit supplies moisture to a recording medium stacked later on the stacking unit so that the amount of moisture supplied to the recording medium stacked later on the stacking unit is smaller than the amount of moisture supplied to a recording medium stacked earlier on the stacking unit.

10. The recording medium processing apparatus according to claim 8, wherein:
the recording medium processing apparatus has a predetermined threshold value, and
a larger amount of moisture is supplied to a recording medium stacked earlier than the predetermined threshold value than to a recording medium stacked later than the predetermined threshold value.

11. The recording medium processing apparatus according to claim 8, wherein:
the recording medium processing apparatus has a predetermined condition, and
in a case where the predetermined condition is satisfied, a predetermined constant amount of moisture is supplied to a recording medium satisfying the predetermined condition even when orders of stacking are different.

12. The recording medium processing apparatus according to claim 10, wherein:
the recording medium processing apparatus has a predetermined condition, and in a case where the predetermined condition is satisfied, a predetermined constant amount of moisture is supplied to a recording medium satisfying the predetermined condition even when orders of stacking are different.
